(19) United States
(12) Patent Application Publication
(10) Pub. No.: US 2012/0028609 A1
(43) Pub. Date: Feb. 2, 2012

(54) Secure financial transaction system using a registered mobile device

(76) Inventor: John Hruska, Stuart, FL (US)

(21) Appl. No.: 13/136,218

(22) Filed: Jul. 26, 2011

Related U.S. Application Data
(60) Provisional application No. 61/367,949, filed on Jul. 27, 2010.
(60) Provisional application No. 61/367,954, filed on Jul. 27, 2010.

(51) Int. Cl. H04L 9/32; H04L 9/14; H04W 12/06

(52) U.S. Cl. 455/411; 705/67

(57) ABSTRACT

A secure system and method are disclosed to effectuate financial transactions over a secure internet backbone establishing and using a secure financial proxy account and a pre-registered personal handheld mobile device where all funds within the account remain in an “inactive” non-usable state until activated and allocated only by the registered mobile handheld device.

### SUMMARY OF THE INVENTION

The invention describes a secure mobile wallet financial transaction system by allowing users (both customers and merchants) to set up a secure financial proxy account, and using registered mobile hand held devices (smartphone, non-smartphone and tablets) that can securely transact payments either using a tablet/mobile hand held device (smart phone) based POS, an automated teller machine (ATM) or an on-line checkout using secure proprietary applications for customers by generating unique user and device specific, single-use, time-sensitive, alpha-numeric digital tokens and the transactional server encrypting these tokens with a customer's personal public/private encryption key specific to the registered mobile device application; the user is able to activate and allocate a specific amount of funds from his pool of funds.

The invention describes a user setting up a financial proxy account; a unique registration and authentication process of the user's mobile handheld device to the financial proxy account, a proprietary unique mobile application downloaded to the registered device, a registered merchant with a secure proprietary POS application on their device or website checkout page, or ATM. Using the consumer's registered mobile hand held device, a proprietary mobile phone application, a registered merchant's handheld wireless POS terminal (Tablet-POS) or a stationary wired device (ATM/Kiosk/POS) with the system's proprietary POS application software capable of recognizing, decoding and validating the user and device specific, single-use, time-sensitive unique encrypted transactional digital token codes from the registered mobile device and the back end transactional server able to decrypt and approve/disapprove the transaction based on the transactional digital token information providing a secure closed loop environment for secure transactional payment processing. The invention also provides for an option to include non-smart phones through the use of a java-based non-smartphone application through a telecommunication data network or SMS and MMS text-messaging protocol.

Similarly using the same financial-proxy system as described above a Merchant sets up a financial business proxy account providing all necessary personal identifying information and is able to download the financial proxy account system's point of sale application (POS) to their registered telecommunication hand-held device, or to their website for e-commerce or be able to integrate this into an existing current POS system.

What is described is a secure mobile based financial proxy system, for both consumers and merchants using their registered handheld devices while at the same time providing the security of a unique closed loop system using proprietary mobile phone and POS applications which recognize the system's uniquely encrypted, consumer and mobile device specific digital transactional tokens to authenticate and process payment or other type of transactions securely. The system can also be used in an automated teller (ATM) setting and in an online transaction purchase setting obviating the need for an ATM card or the transmission of any personal information into the ATM or during an on-line purchase checkout.

### BRIEF DESCRIPTION OF THE DRAWINGS

FIG. 1 shows the Process Flow of the Secure Financial Proxy Account Set-Up

FIG. 2 shows the Process Flow of the Using a Smart Phone Mobile Device Application to Allocate Funds

FIG. 3 shows the Process Flow of how a Merchant Sets Up a Secure Transactional Purchase

FIG. 4 shows the Transaction Description Flow for the Point Of Sale Using a Barcode Scanner

FIG. 5 shows the Alternate Transaction Description Flow for the Point Of Sale Using a Camera to Capture or Take a Picture of the Barcode

FIG. 6 shows the Alternate Transaction Description Flow for the Point Of Sale Using NFC, Optical, Infrared, RFID, etc.

FIG. 7 illustrates the Process of Forming a Proprietary Encrypted Barcodes Using Private Key/Public Key Authentication

FIG. 8 shows How to Scan a Proprietary Barcode to Make a Purchase

### DETAILED DESCRIPTION

### Step 1

### Account Set-Up

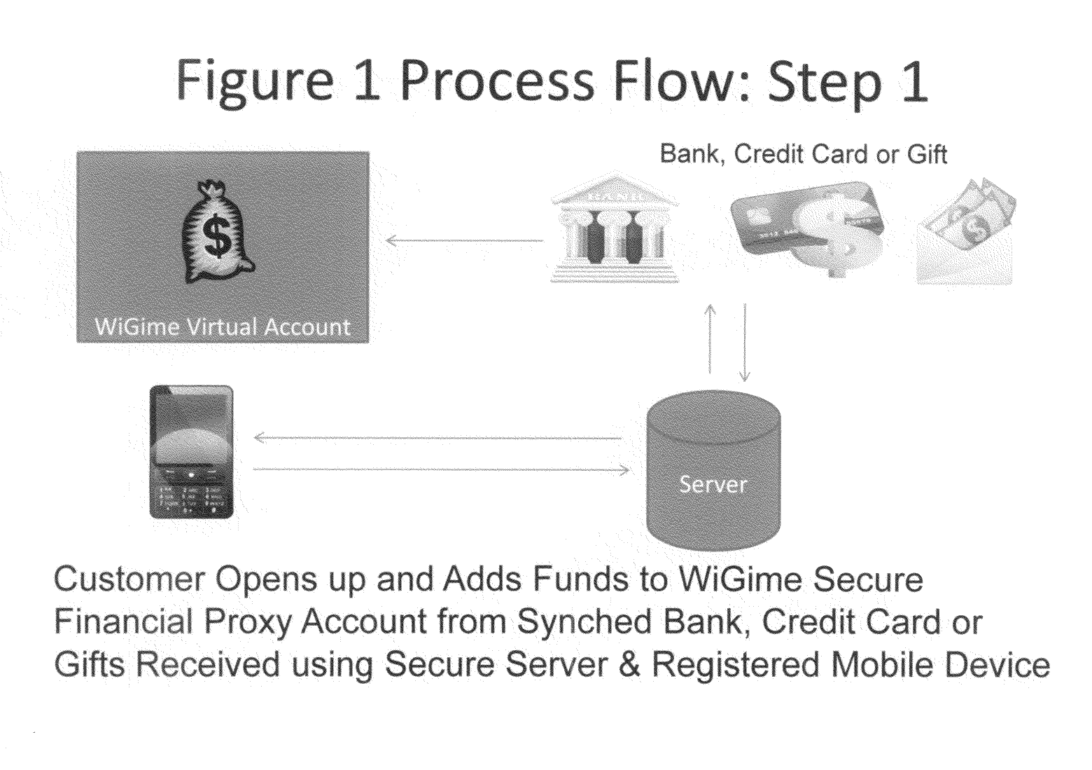

As shown in FIG. 1, a user establishes a secure proxy financial account with an electronically-based financial-type of institution over a web-based mobile phone or web-based PC. After identifying the mobile phone using either the phone number or machine identifier number, a uniquely specific mobile phone application is sent to the phone through an sms (“Short Message Service”) link. Once the mobile specific link is opened account set up and phone registration takes place; the user provides all necessary personal information including a personal Identification (PIN) number and as an option provides additional personal identifying biometric features using various phone feature modalities (the camera for facial recognition, the microphone for voice spectral analysis and recognition and/or finger print reader device accessory built into some mobile handheld devices). This data is gathered and passed to and stored on the authentication server. Once the data is collected in the same session the mobile handheld device is registered by sending to the mobile device a unique single-use time sensitive authentication code developed by the back-end system and sent to the mobile through a separate channel (sms or voice). The authentication code is required to be entered during the application set up session to complete the account set up and registration process. At completion of the mobile phone registration process an application specific public/private key may also get assigned to the handheld devices account and get uploaded to the mobile phone application to securely complete the account set up and phone registration, in one variant of the invention.

Using the mobile phone application the user chooses an amount of money and inputs a personal identifier (PIN) through a graphical interface (GUI) and the application can gather other biometric information. In the increased security variant, the Information gets encrypted using the public/private key protocol specific to the mobile application/hand-held device and sends the information as a request to the authentication server. The server side application validates the request by authenticating the hand-held device initially by identifying the hand-held device using the mobile devices phone # (which is NOT encrypted with the Private/Public key) and provides for account look up, The hand-held device's private key is used to decrypt the remaining authentication information, identifying the unique application Identifier and the user's personal information (PIN and Biometric data) and the MEIN/Device number. This data is compared to the one-way hashing results obtained during the phone registration and mobile application set up process. Once authenticated the transactional server verifies the requested amount is available and if so the algorithmically generates a user and device specific numeric or alphanumeric encrypted digital token which identifies the mobile device, the user, and the specified requested amount. The user and device specific digital token gets encrypted with the accounts public key and is transmits to the mobile phone device over a secure protocol (SSL) 256-bit encrypted channel. After being received by the specific mobile device the application decrypts the information using the private encryption key to obtain the originally generated digital token. The encrypted digital token is transmitted to the merchant's point of sale through various modalities as described within by being optically displayed or manually inputted at a proprietary point of sale (POS or ATM) system which facilitates the completion of the intended transaction.

### Step 2

### Using a Smart Phone Mobile Device Application to Allocate Funds

As was described in Step 1 and illustrated in FIG. 1, the customer who is seeking to effectuate a secure mobile financial transaction (mobile wallet) opens a secure financial proxy account which may optionally be associated with their main bank accounts or credit/debit card. After providing all personal information (Name, Address, Mobile Country Code, Mobile Number, PIN#, Security Questions) and obtaining biometric information in the way of facial recognition data through front facing mobile device camera, or voice recording data, or fingerprint data to set-up their secure financial proxy account. (Note: Most mobile devices to date are equipped with a front facing camera which may take various facial measurements (as are presently standardized and accepted in the biometric validation industry), providing an additional layer of security utilizing the measurements for a biometric validation application component. These points are captured during set up of the application and stored in the users account. They are passed to the authentication server to be subsequently utilized in conjunction with the pin # (to authenticate the user for a requested transaction.)

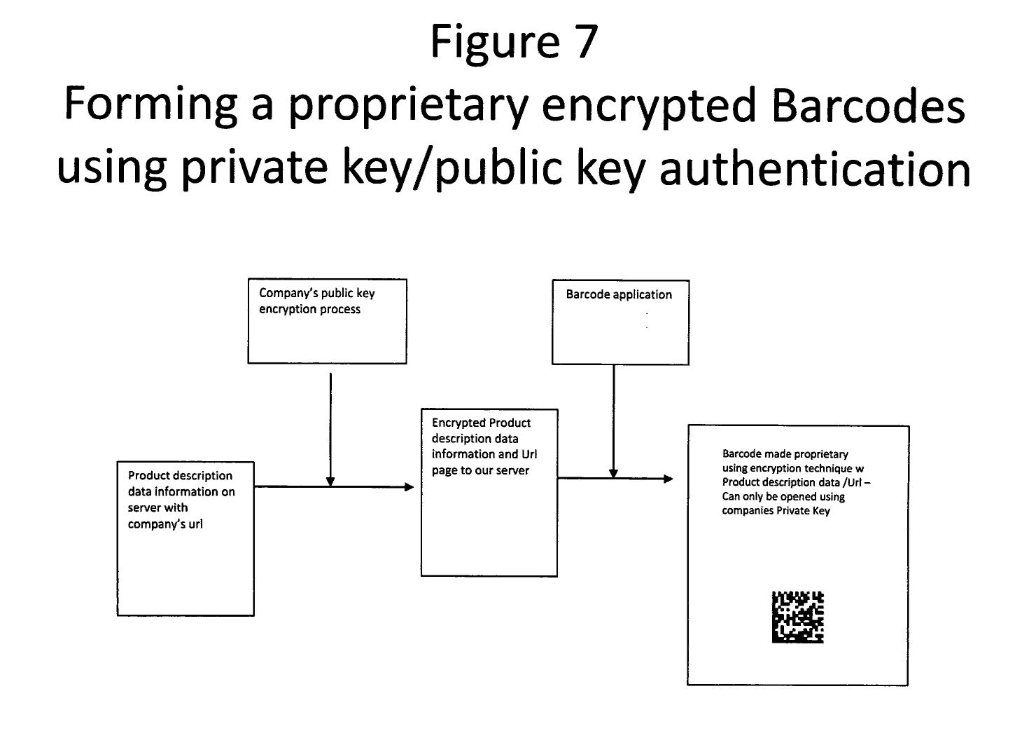

In the same account set-up session the user's mobile phone is subsequently registered to the account using the telecommunication network by sending the mobile phone a unique authentication code to the mobile number (either by voice channel or a data channel) which is required to be entered by the user during the account set up process session in order to register their mobile device and to successfully complete their account set up process. All the personal account information and security informational data is obtained, except for the mobile country code and mobile number, is stored and encrypted using a one-way hash function by the authentication server. A text message (SMS) containing a link for the system's mobile phone application is sent to the registered mobile device which allows for the system's proprietary application to be downloaded to the hand-held device. Once the link is opened the application is downloaded, the application setup process takes place for the specific hand held device obtaining specific authentication data providing the authentication server with the following: a dynamically generated Unique Application Alphanumeric Identification Number (both stored on the application and stored on the authentication server), the user's PIN# (and other biometric information if available (voice, facial recognition profile), the hand-held device machine equipment number identifier (MEIN# or MEID#) and the unit's mobile phone number including the mobile country code. Once all this authentication information is obtained by the authentication server a one-way hashing encryption function is utilized on this data (except for the mobile no.) and the results stored on the authentication server in the user's account. Subsequent to obtaining and storing this information the authentication server application may also create a unique Public/Private Encryption Key for that specific user and their mobile phone application and is both transmitted to the mobile phone application and is stored on the authentication server within the user's account. This is described in Process Flow in FIG. 7.

As shown in FIG. 1, funds can be loaded through various resources (direct deposit, gifting, bank accts etc. . . . ). The funds within the account remain in an ‘inactive or dormant” state. Only the user and the user's registered mobile hand-held device, after being authenticated can “activate/allocate” a specific amount of funds to be used within a specified given amount of time.

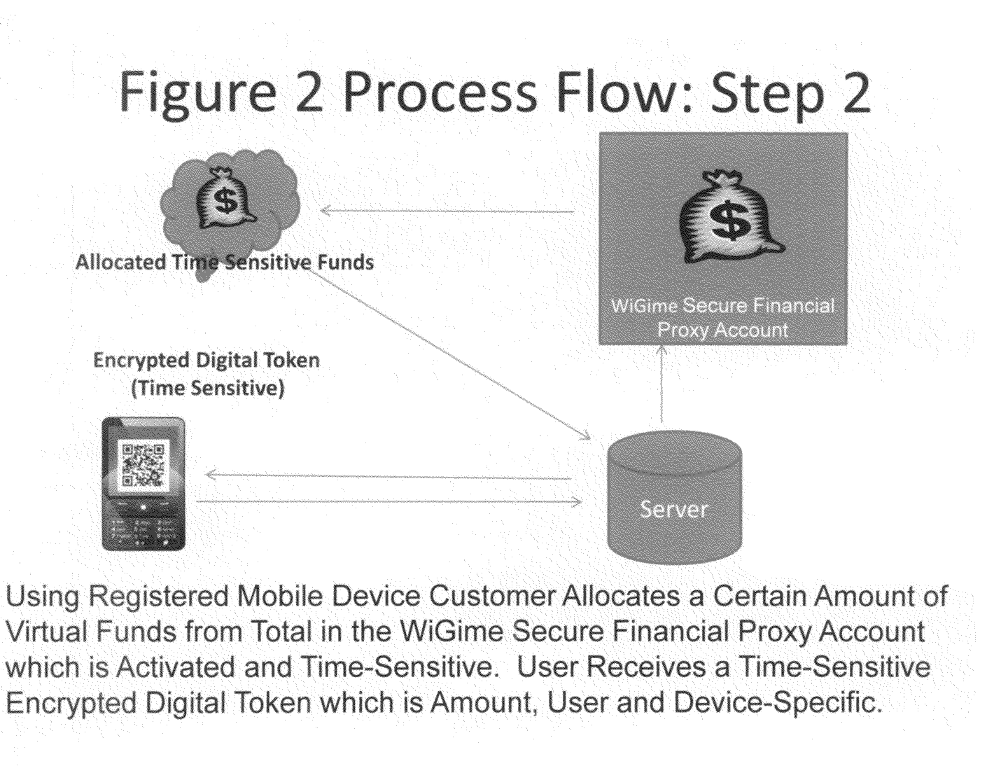

As shown by FIG. 2, a request is sent to the back-end authentication server over 256-bit encryption protocol as follows: Using the mobile phone application the user requests a certain amount of funds to be allocated from the dormant inactive state of funds by selecting the currency and an amount of funds needed and then the user provides their personal identifier information in the way of a PIN and the application obtains additional biometric information. A further embodiment involves using the user's hand-held device public encryption key (which was assigned and downloaded from the system to the application during application set-up) the following data gets encrypted using the user's public key: the mobile device (MEIN# or MEID#), the uniquely generated application identifier-UID, and the customer's personal information (including biometric information obtained). In the enhanced security variant, all the aforementioned data gets encrypted with the user's public key except for the hand-held device mobile number which is used as a look up identifier gets passed to the authentication server. Authentication of the user and the hand-held device occurs after decrypting the information using the user's assigned private key obtaining the authentication information and using all or any combination of this information in an authentication protocol on the application server.

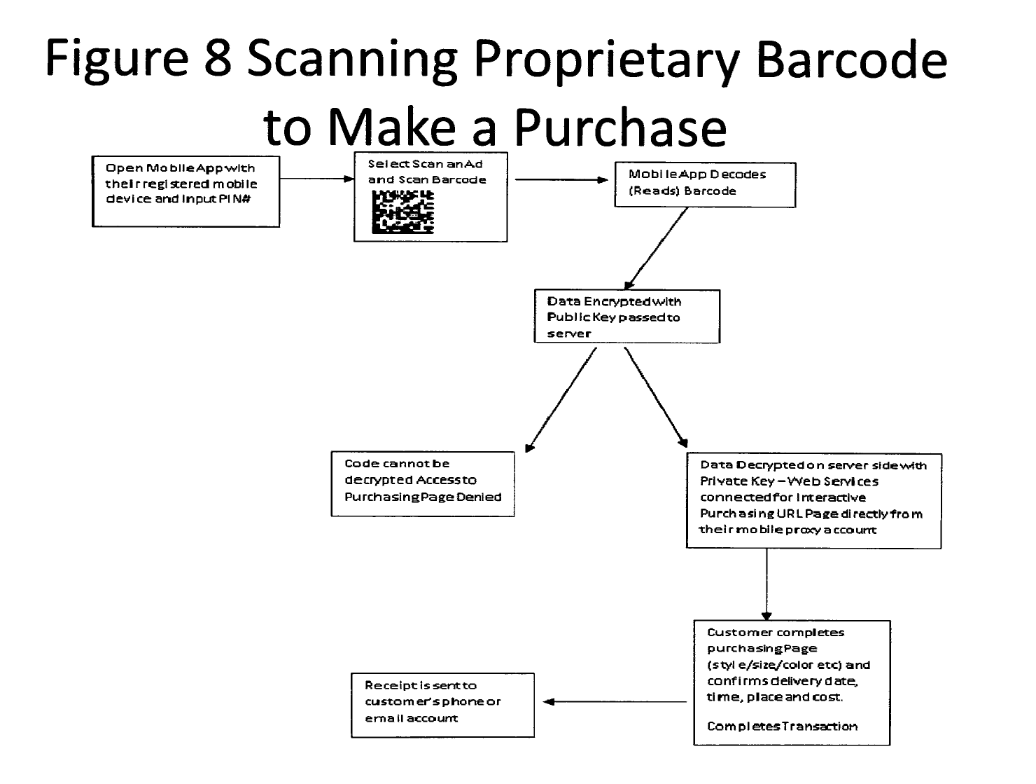

Once the authentication process has been completed, a user and device specific, algorithmically generated time-sensitive, single-use numeric or alphanumeric encrypted digital token is generated as a valued digital token against those specifically requested funds which now become allocated and active for pending use. Using the user's assigned public/private encryption key the algorithmically generated digital valued token is encrypted with the user's public key and sent to the specific registered mobile device using the telecommunication network thus activating and allocating the customer's account for the requested funds as for a potential pending transaction, as explained in FIG. 8. Using a secure transport protocol (SSL/TSL-256 bit encryption) the information get passed to the specific mobile hand-held device, and the results may be decrypted using the user's private encryption key on the mobile application in the enhanced security variant, and are displayed in numeric or alphanumeric terms for manual input and/or as an optical representation such as a barcode or some other optically encoded depiction.

### Step 3

### Merchant Sets Up Secure Transactional Purchase

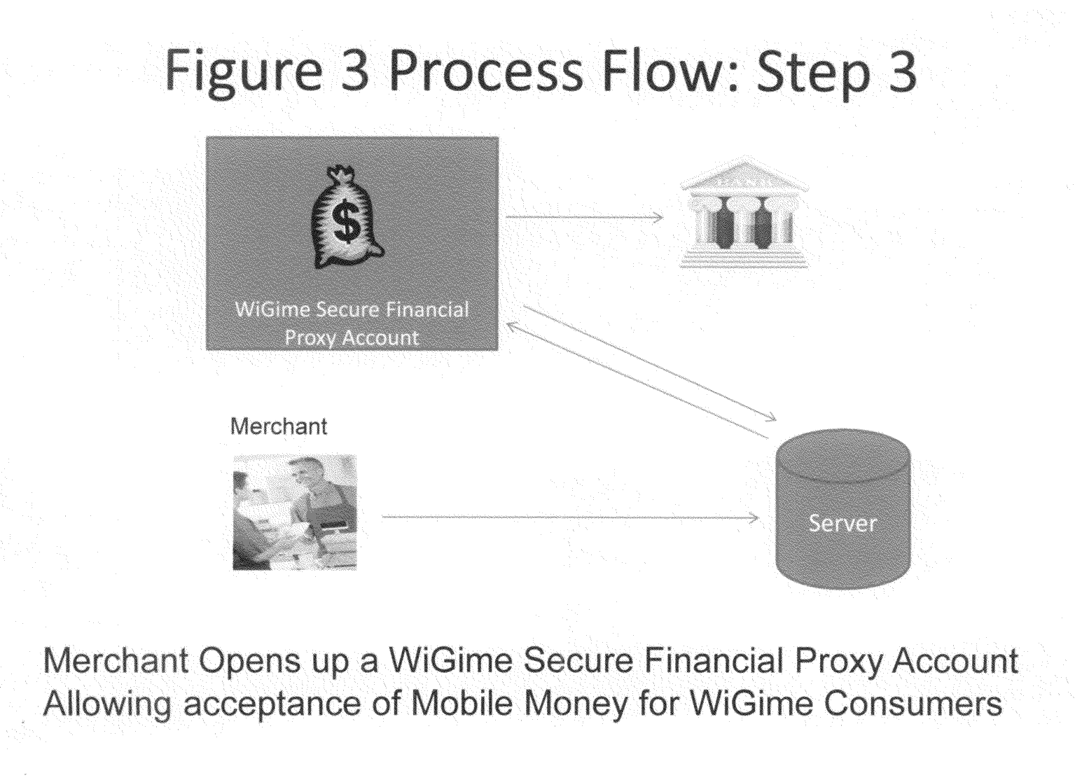

FIG. 3 illustrates how the Merchant (or Financial Institution) adds its level of security. At a registered Merchant's POS, ATM or Website checkout containing the system proprietary point of sale application the user's unique time-sensitive, single-use unique transactional digital token code gets transmitted to the point of sale application using one of several transmitting modalities gets validated for being proprietary and having the correct price; then is passed to the system's transactional server for processing over ssl/tsl 256-bit encryption protocol. The transactional server verifies the code is active for the specified mobile phone account and processes and confirms the transaction. Once the uniquely encrypted digital transaction (token) code is used, it becomes inactive and useless for any additional transactions and can never be repeated for the user's specific account.

The Modes of Transmission can vary. The digital token information from the mobile device is displayed and may be entered manually into the POS application along with the mobile device's phone number, or be encoded as a barcode image (or other type of optical depiction) and be captured by the POS device using a camera or CCD type device that reads and decodes the bar-code graphic. In Addition in the field of possibilities is wireless automatic transmission, including near field communication (NFC), Bluetooth (BT), and Infrared (IR), Light Transmission protocols, audio frequency transmission or Wi-Fi etc. including further developments in this field.

### Using a Non-Smart Phone Mobile Application

Furthermore, even with a Non-smart phone and using a Java-based mobile application, a user can activate their account using encrypted sms, mms, ussd type protocol to obtain the previously above described information in a similar manner described as follows.

The user opens the java-based mobile application sms function of their registered mobile device. He/she types in the known short code or long-code telephone number for the account financial-like entity that supports and manages the mobile account. The user then sends a request to activate a specified amount of funds from their secure proxy account using their PIN# The request is encrypted with a private/public key encryption and is sent to the authentication server to authenticate the user's handheld device and the transaction amount request. After verification and authentication an algorithmically generated user and device specific, single-use time-sensitive pseudorandom numeric or alphanumeric encrypted digital token is generated and assigned to user account for the specified amount, gets encrypted using the user's private/public key and sent over the telecommunication network to the specific phone. The java-based mobile application decrypts the digital valued token so that the user then can manually enter this at either an ATM/or POS into the appropriate fields along with their mobile device number and their personal identifier information. The back-end transactional server then confirms and executes the request processing the described transaction in all the above material.

### Merchant Sign Up to System

Using a web-session to sign up and open the account a merchant provides all pertinent information; the Information confirmed using the Business ID using tax ID# or some other type of business identification for verification. During the same session the merchant creates a Username and Password and registers a handheld mobile device (or tablet) to be used as their mobile point of sale (mPOS) and downloads the proprietary point of sale application (POS). Similarly to the customer's set up the merchant mobile POS application set up provides the authentication server with the MEIN#, a mPOS application unique Identifier number (created from the application), the unit's telephone number (Tablet or mobile smart-phone) and the Merchant's Password.

Once the account set up and registration is completed a Financial Proxy Account is created for the merchant, similar to the customer, to allow payment reconciliation between the merchant's account and customer's account using their respective registered mobile handsets.

### Step 4

### Transaction Description Flow—Point of Sale

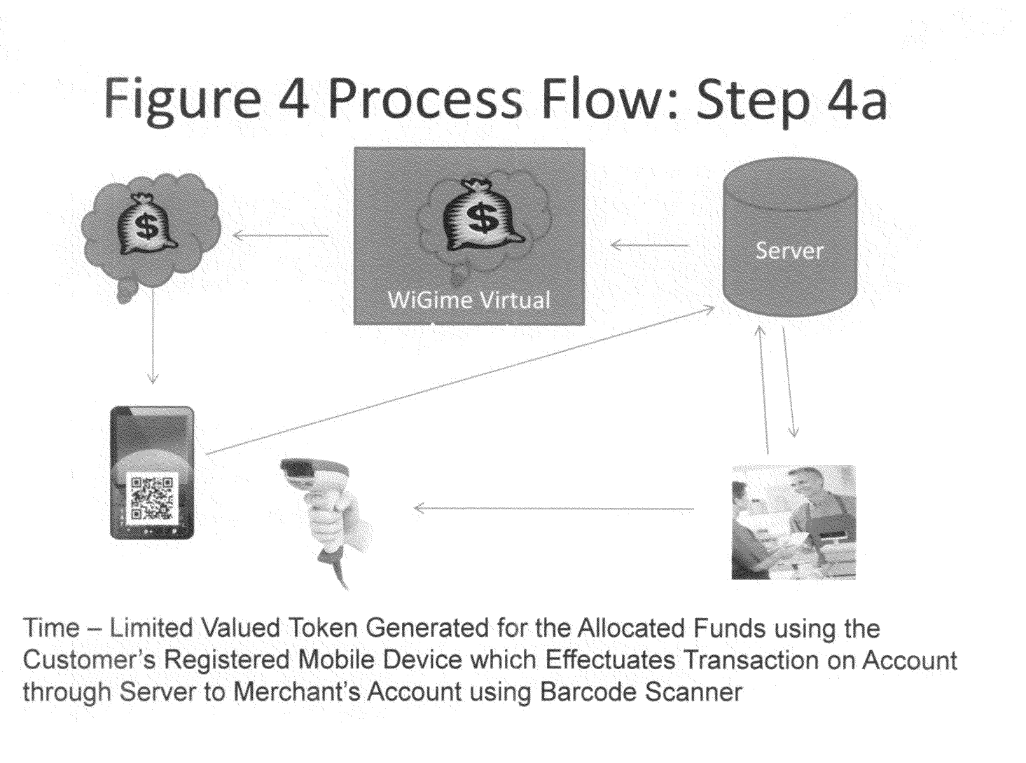

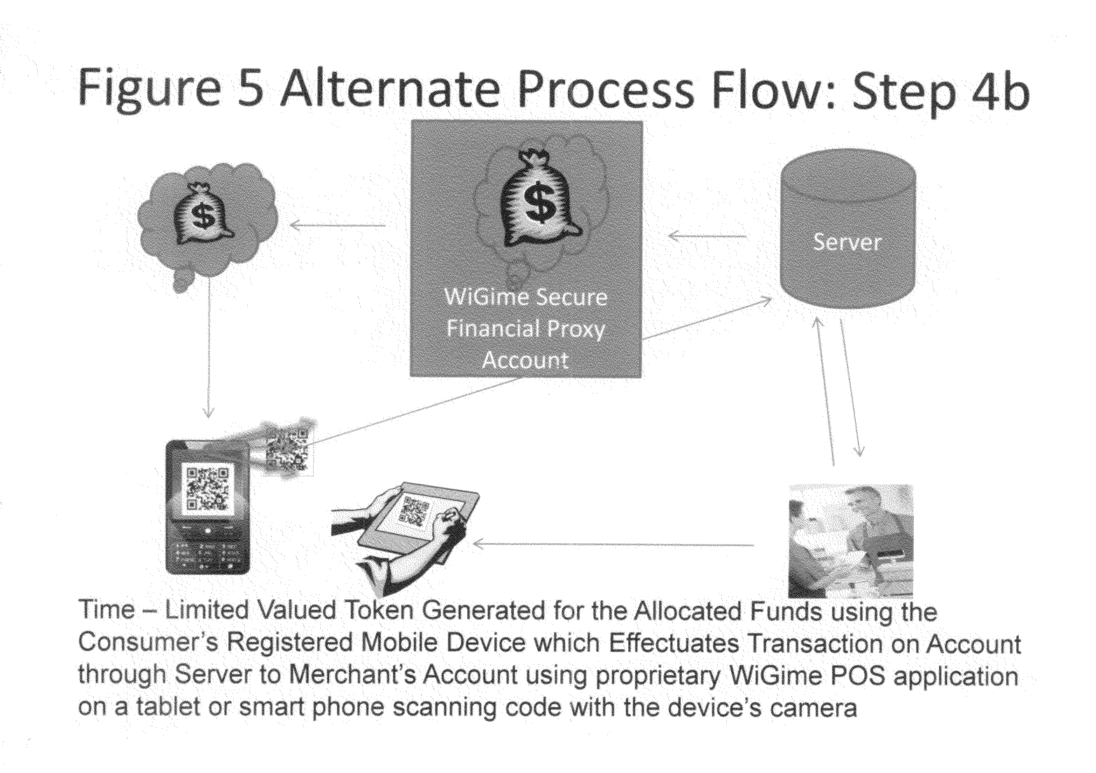

A registered user requests and specific amount and activates the funds their account using their registered mobile phone application. After being authenticated the user receives a unique time-sensitive, single-use, encrypted digital token code to their device. The merchant opens their registered POS application on the device and is also authenticated using a similar authentication protocol. As shown in FIGS. 4 and 5, using the device (and application) the merchant can scan (4a) or takes a picture (4b) of the digital token being depicted as a barcode which decodes the barcode representation of the token. Alternatively, as in FIG. 5, the user's digital token information can be passed using NFC, an audio wave form, or light medium to transfer the information directly to the POS (4c). The POS application validates the digital token information confirming it is proprietary prior to sending the information to the transactional server for processing. The transaction server verifies the digital token is proprietary to the system's application authentic using the user's Public/Private key encryption, verifies the digital token code is active in the system for the specified amount confirming or disapproving the transaction.

Upon approval of the transaction real time reconciliation of the account takes place debiting the user's proxy financial account and crediting the merchant's proxy financial account. The monies do not leave the system remaining in the pooled financial proxy account at all and securely stay within the original financial entity.

### Transaction Description Flow

### Automated Teller Machine or Financial Institution

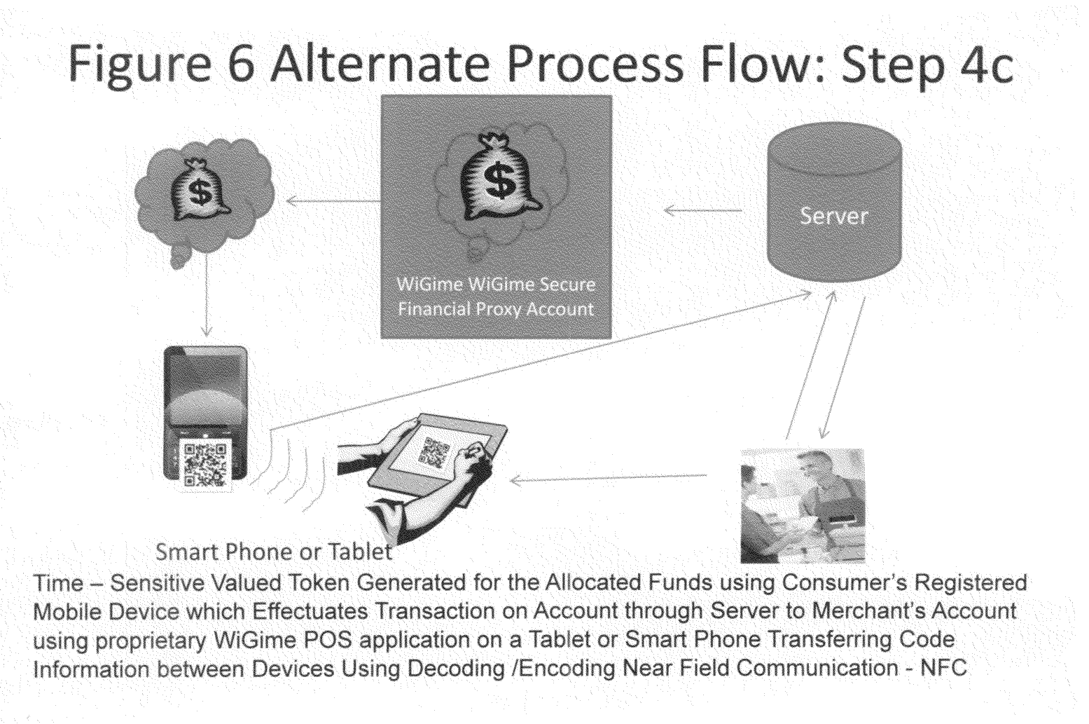

A registered user activates their account using their mobile phone and after being authenticated receives a user and device specific, unique time-sensitive, single-use encrypted digital token to their device. The user selects the system's ATM application to receive money. Using manual input or the ATM built-in camera device, (and application) scans or takes a picture from the user's mobile phone screen and decodes the barcode representation of the encrypted digital token, as shown in FIG. 5. Alternatively, the user can use NFC or other modalities to transfer the digital token information as shown in FIG. 6. Similar to the “Transactional Description Flow for the POS above, the ATM application validates the information confirming it is from a registered user's mobile device application prior to sending the information to the transactional server for processing. The transactional server verifies the active encrypted digital token code for the specified amount and sends approval to ATM to dispense correct amount. Funds get transferred to ATM owner's main bank account on file or credited to the ATM owner's financial proxy account within the system.

### Step 4

### An Alternative Secure Transaction

As shown in FIG. 4, Retail merchants that sign up to the system are able to provide information regarding their product including description, price, reserve price, volume, colors and website address to the system's web services. The web service creates a unique barcode for the aforementioned information which will allow for direct purchase and a secure transaction by a user scanning the barcode information using the registered mobile device application. The merchant is able to display the barcode in advertisements (e-media, online, print media etc. . . . ). The user can open the mobile application enter their required authentication information and scan the barcode. The barcode information and the authentication information get passed back to the authentication and transaction server to authenticate the user. This Process Flow is shown in FIG. 8. Once the user is authenticated, in the same session using the website address the product description along with a picture and a purchase option is offered to the user using the mobile application. Once the purchase option is selected a unique user and device specific, time-sensitive, digital token is generated for the amount and allocated from the dormant funds from the user's secure proxy account and is sent to the merchant's secure proxy account for purchase. A receipt is generated and sent to the user phone and account confirming the purchased item and is delivered to the user using the address on file.

TABLE 1
Creation of a Unique User and Device Specific, Time-Sensitive, Single-
Use Encrypted Digital Token Used for Purchase Transactions
Generate a Random Number Seed: 5423687225

| Authentication Info | Number | Number (Mod8 + 2) |
|---|---|---|
| 1) Mobile # | 444-555-2222 | 6667774444 |
| 2) Mobile Equip # | 4444222255 | 6666444477 |
| 3) Application ID # | 5555333366 | 7777555588 |
| 4) Random # Seed (above) | 5423687225 | 7645829447 |
| 5) User's PIN # | 5246669541 | 7468883763 |

Algorithm
1) Calculate exponent component
Use the Last Column and Add Each Number in Their Respective Column to be used as exponents: Ex: (6 + 6 + 7 + 7 + 7) = 33 Ex: (6 + 6 + 7 + 6 + 4) = 29 Ex: (6 + 6 + 7 + 4 + 6) = 29 Ex: (7 + 6 + 7 + 5 + 8) = 33 etc . . .
2) Calculate Base Component
Use the random number results from the mod 8 + 2 function as the bases (7645829447)
Example: (base from step 2)\hat{ }(exponent from step #1)
7\hat{ }³³, 6\hat{ }²⁹, 4\hat{ }²⁹, 5\hat{ }³³ . . . using all bases from step 2 to obtain 10 groups of numbers. Select 2 numbers from each group to obtain a 20 digitally unique random number which is to be used as the uniquely generated WiGime transactional code.
Example: 45866932145698756321→ this token gets one -way Hashed and stored in database under mobile account #: 0001-444-555-2222
The Country Code + Mobile Number + the Un-Hashed token gets encrypted using the user's assigned WiGime's Public key/Pvt Key
Example: 0001- 4445552222-45866932145698756321→ Apply User's Public Key
Encrypted Token result gets sent to specific mobile device gets decrypted by the user's assigned WiGime Private encryption key and gets depicted on the mobile hand set device as a Barcode or gets passed to mobile handset as digital information to be transferred to a WiGime's Point of Sale Application (POS)

TABLE 2
Database Storage of Account Information and Private/Public
Key Encryption of the Encrypted Digital Token

| Authentication | | One- Way | Con- |
|---|---|---|---|
| Info | Number | Hashed (Database) | firmed |
| 1) CC+ Mobile # | 0001+444-555-2222 | 6667774444 | yes/no |
| 2) Mobile Equip # | 4444222255 | 6666444477 | yes/no |
| 3) Application ID # | 5555333366 | 7777555588 | yes/no |
| 4) User's PIN # | 5246669541 | 7468883763 | yes/no |

The second column (“Number”) Steps 2-4 get encrypted using the User's assigned WiGime Public Key
Step #1 gets passed also to authentication server for account look up
Each step above needs to be confirmed for authentication to be processed
When all steps are confirmed a Random number generator is used to create a 20 digit random number to be used as the digital token against the requested funds from the account
Example: 45866932145698756321→ this token gets one -way Hashed and stored in database under mobile account #: 0001-444-555-2222
The Country Code + Mobile Number + the Un-Hashed token gets encrypted using a user's WiGime Public key/Pvt Key
Example: 0001- 4445552222-45866932145698756321→ Apply Public Key
Encrypted Token result gets sent to handset, decrypted using the device's Pvt key and gets depicted onto the mobile hand set device as a Barcode or gets passed to mobile handset as digital information to be transferred to WiGime's Point of Sale Application (POS)

TABLE 3
User Authentication from a Registered
Mobile Phone and Mobile Application

WiGime Account creation and mobile application set up allows the system
to obtain uniquely identifiable information for identifying and
authenticating: 1) The User, 2) The Hand Set and 3) The Mobile
Application when being authenticated for an encrypted WiGime digital
token against requested funds from the user's account. The following
information is obtained during mobile application set up:
1) Country Code + Mobile Cell Phone #--> Passed to server and
stored in the database for the mobile account and hand set device
2) Mobile Equipment ID# → passed to server and one-way hashed in
the database for the mobile account and hand set device
3) Unique Application ID (generated during set up) → Passed to server
and one-way Hashed in the database for the mobile account and hand set
device
4) Personal Identification Number (PIN#)→ Passed to authentication
server and one-way hashed for the mobile hand set device
Steps 2 through 4 get encrypted on the mobile application using the
user's assigned WiGime Public encryption key
Step 1 can remain un-encrypted OR optionally can be encrypted with the
Company's Public Encryption Key.

TABLE 4
Authentication of User/Handheld Device to Request Activation
and Allocation of Funds from User's Financial Proxy
Account on Authentication and Transactional Server

| | | One- Way | |
|---|---|---|---|
| Authentication Info | Number | Hashed Data | Confirmed |
| 1) CC+ Mobile # | CC+444-555-2222 | NOT Hashed | yes/no |
| 2) Mobile Equip # | 4444222255 | 6666444477 | yes/no |
| 3) Application ID # | 5555333366 | 7777555588 | yes/no |
| 4) User's PIN # | 5246669541 | 7468883763 | yes/no |

When an encrypted digital token is requested for specific amount of funds the information above gets passed from the mobile hand set device using the registered mobile application and sent to the authentication server (steps 2-4)encrypted using the user's assigned WiGime PUBLIC Key from a Public/Pvt encryption key (residing on the user's mobile device) and sent over to authentication server using (SSL). After the mobile account is looked up using the Country Code and Mobile number, the information is decrypted using the user's assigned WiGime PVT KEY, the information compared to the hashed account authentication information. Each step above needs to be confirmed for authentication to be approved
When all steps are confirmed authentication process is complete and the transactional server creates a pseudorandom digital token on behalf of the user and device for the requested amount as described previously.

I claim:

1. A system on a computer based network for secure transfer of a customer's funds, comprising:
a secure financial proxy account such as an online wallet, established for the purpose of holding unused dormant customer funds until activated and allocated by means of a pre-registered personal handheld device;
a personal handheld device;
a registration protocol for the personal handheld device;
a mobile application installed on the personal handheld device;
a unique authentication identification number for the personal handheld device and for the mobile application installed on that device;
an activation protocol for identifying the account's registered handheld device, its mobile application, its owner and its location coordinates for making the account and funds active for a particular desired transaction with a specific merchant or financial institution for a specified amount for a specific configurable amount of time;
a transactional and authentication server which stores and authenticates data sent from the customer's personal handheld device sent over a telecommunications network;
and a unique customer and device specific, time-sensitive, single-use encrypted digital transactional alphanumeric token created by the transactional and authentication server which is specific to the handheld device, its location, and the customer's personal identification information for consummating the particular transaction with the specific merchant or financial institution.

2. The system of claim 1, further comprising:
a point of purchase barcode scanner on the personal handheld device to identify the specific merchant or financial institution with whom the transaction is to be consummated;
a point of sale token scanner device; and
a linked proprietary application used to authenticate the specific merchant or financial institution, the specific customer and device, and the subject matter for the transaction by identifying and validating the unique customer and device specific, time-sensitive, single-use encrypted digital transactional alphanumeric token.

3. The system of claim 1, where the personal handheld device is a telecommunication device with access to a telecommunication data network.

4. The system of claim 3, where the personal handheld device is a smartphone.

5. The system of claim 3, where the personal handheld device is a tablet device.

6. The system of claim 1, further comprising:
a front facing camera on the personal handheld device to take various industry-standardized facial measurements; and
a biometric validation application component which combines the facial measurements into the customer's personal identification information for further validation at the authentication server.

7. The system of claim 2, wherein the point of sale token scanner used by the specific merchant or financial institution is a registered handheld or stationary telecommunication device for that specific merchant or financial institution linked to a telecommunications network;
the unique customer and device specific, time-sensitive, single-use encrypted digital transactional alphanumeric token is represented as a barcode or a graphic;
and the proprietary application identifies and validates the unique customer and device specific, time-sensitive, single-use encrypted transactional alphanumeric digital token using barcode scanning methods.

8. The system of claim 1, wherein the specific handheld device of the customer, and another telecommunication handheld or stationary device of the merchant or financial institution are enabled to communicate the unique customer and device specific, time-sensitive, single-use encrypted digital transactional alphanumeric token using a near-field communication, Bluetooth, infrared, light transmission protocols, audible frequency, sms, mms, wi-fi or other suitable synchronizing protocol over a telecommunications network.

9. The system of claim 7, wherein the specific handheld device of the customer, and another telecommunication handheld or stationary device of the merchant or financial institution are enabled to communicate the unique customer and device specific, time-sensitive, single-use encrypted digital transactional alphanumeric token using a near-field communication, Bluetooth, infrared, light transmission protocols, audible frequency, sms, mms, wi-fi or other suitable synchronizing protocol over a telecommunications network.

10. The system of claim 1, wherein:
the registration protocol for the personal handheld device further comprises:
generating on the transactional and authentication server public and private encryption keys specific to the customer and the mobile device application; and
sending the public and private encryption keys to the personal handheld device and its mobile application; and
the activation protocol further comprises:
encryption by means of the mobile application the unique authentication identification number for the personal handheld device and the mobile application, and the personal identification information for the customer with the customer's assigned public key;
decryption of the authentication identification number and the personal identification information and the desired transaction by the transactional and authentication server using the customer's assigned private key;
permanently hashing the results of the decryption by means of a one-way hash function;
and comparison of these decrypted hashed results to the stored data on the transactional and authentication server for the specific customer's account; and
the unique customer and device specific, time-sensitive, single-use encrypted digital transactional alphanumeric token is encrypted by the transactional and authentication server using the customer's assigned public key, is sent over a secure telecommunication network to the personal handheld device, and is decrypted at the device using the user and device specific private key located on the mobile application.

11. A method for secure transfer of customer funds, comprising the steps of:
establishing an online account for a customer to hold dormant, unused funds for the customer;
linking the online account to a transactional and authentication server wherein an application resides to effectuate transfer of secure funds;
registering the customer's personal handheld device onto the server via an appropriate protocol;
generating a unique authentication identification number for the personal handheld device and for a mobile application installed on the personal handheld device;
identifying the account's registered handheld device and its owner for making the account and funds active;
activating funds in the an online account for the customer via an appropriate protocol for a particular transaction with a specific merchant or financial institution in a specified amount for a specific configurable amount of time;
generating a unique user and device specific, time-sensitive, single-use encrypted digital transactional alphanumeric token by the transactional and authentication server using the unique identifier of the specific handheld device, the unique identifier of the mobile handset's applications, and the customer's personal identification information, for the purpose of consummating the particular transaction with the specific merchant or financial institution;
transmitting the unique user and device specific, time-sensitive, single-use encrypted digital transactional alphanumeric token by an ssl or tls or other secure protocol over a telecommunications network from the transactional and authentication server to the specific handheld device;
inputting this unique user and device specific, time-sensitive, single-use encrypted digital transactional alphanumeric token at the system's point of sale or ATM application;
sending the unique user and device specific, time-sensitive, single-use encrypted digital transactional alphanumeric token, and the identifier of the handheld device to the transactional server; and
verifying the unique user and device specific, time-sensitive, single-use encrypted digital transactional alphanumeric token from the identifier of the handheld device by means of an appropriate secure transactional encryption and decryption algorithm.

12. The method of claim 11, further comprising the steps of:
scanning a barcode by means of a point of purchase barcode scanner on the personal handheld device so as to identify a merchant or financial institution and subject matter for the transaction;
using the barcode information in the generating step for the unique user and device specific, time-sensitive, single-use encrypted digital transactional alphanumeric token;
transmitting the unique user and device specific, time-sensitive, single-use encrypted digital transactional alphanumeric token to the merchant or financial institution via a telecommunications network;
scanning the unique user and device specific, time-sensitive, single-use encrypted digital transactional alphanumeric token, represented graphically, at a point of sale token scanner used by the specific merchant or financial institution;
identifying and validating the unique user and device specific, time-sensitive, single-use encrypted digital transactional alphanumeric token to consummate the transaction by means of an appropriate proprietary application.

13. The method of claim 11, further comprising the steps of:
taking various industry-standardized facial measurements by means of a front facing camera of the smart phone;
combining the facial measurements into the user's personal identification information by means of a biometric validation application for further validation at the authentication server;
storing the results of the combination step in the users account;
passing the results of the combination step to the transactional and authentication server over the telecommunications network; and
utilizing the results of the combination step to biometrically validate and authenticate the user for a desired transaction.

14. The method of claim 11, wherein the personal handheld device is a telecommunication device with access to a telecommunication data network.

15. The method of claim 14, wherein the personal handheld device is a smartphone.

16. The method of claim 14, wherein the personal handheld device is a tablet device.

17. The method of claim 12, wherein the proprietary application identifies and validates the unique user and device specific, time-sensitive, single-use encrypted digital transactional alphanumeric token using barcode scanning methods; and
the unique user and device specific, time-sensitive, single-use encrypted digital transactional alphanumeric token is represented as a barcode or a graphic.

18. The method of claim 11, wherein the specific handheld device of the user, and another handheld or stationary device of the merchant or financial institution are enabled to communicate the unique user and device specific, time-sensitive, single-use encrypted digital transactional alphanumeric token using a near-field communication, Bluetooth, infrared, light transmission protocols, sms, mms, wi-fi or other suitable synchronizing protocol over a telecommunications network.

19. The method of claim 17, wherein the specific handheld device of the user, and another handheld or stationary device of the merchant or financial institution are enabled to communicate the unique user and device specific, time-sensitive, single-use encrypted digital transactional alphanumeric token using a near-field communication, Bluetooth, infrared, light transmission protocols, sms, mms, wi-fi or other suitable synchronizing protocol over a telecommunications network.

20. The method of claim 11, further comprising the steps of:
generating and assigning the customer with public and private encryption keys specific to the customer and the mobile device application;
encrypting by means of the mobile application the unique authentication identification number for the personal handheld device and the mobile application, and the personal identification information for the customer and the desired transaction with the customer's assigned public key;
decrypting the authentication identification number and the personal identification information and the desired transaction by the transactional and authentication server using the customer's assigned private key;
applying a one-way encryption hash function by the transactional and authentication server to the decryption results;
comparing this information to the stored data on the transactional and authentication server in order to authenticate the specific customer's account;
encrypting the unique customer and device specific, time-sensitive, single-use encrypted digital transactional alphanumeric token by the transactional and authentication server using the customer's assigned public key prior to the transmission step; and
decrypting after the transmission step the unique customer and device specific, time-sensitive, single-use encrypted digital transactional alphanumeric token by the mobile application at the device using the user and device specific private key.
